(19) United States
(12) Patent Application Publication
(10) Pub. No.: US 2009/0119014 A1
(43) Pub. Date: May 7, 2009

(54) NAVIGATION SYSTEM FOR ALERTING DRIVERS OF NEARBY VEHICLES

(76) Inventor: Seth Caplan, Studio City, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/936,755

(22) Filed: Nov. 7, 2007

(51) Int. Cl. G01C 21/26; G01S 5/00

(52) U.S. Cl. 701/213

(57) ABSTRACT

A navigation system having a transceiver configured to receive a first GPS location signal corresponding to a geographic location of the navigation system and a second GPS location signal corresponding to a geographic location of a vehicle, a processor operatively coupled to the transceiver, the processor configured to determine a relative distance of the navigation system from the vehicle based on the first GPS location signal and the second GPS location signal, and a user interface operatively coupled to the processor, the user interface provides an alert at a predetermined distance from the vehicle.

### BACKGROUND

1. Field

This disclosure relates generally to navigation systems. More particularly, the disclosure relates to a navigation system for alerting drivers of nearby vehicles, inter alia.

2. General Background

Using a Global Positioning System (GPS), current navigation systems can determine the location of the system, and compute directions to navigate to a desired location. For example, prior art vehicle navigation systems can compute a route to a desired location and display the route on a display panel. The navigation system can allow a user to zoom in and out of the displayed route and/or search points of interests, such as restaurants, theaters and ATM machines.

### SUMMARY

A navigation system and method for alerting drivers of a nearby vehicle having a transceiver configured to receive a first GPS location signal corresponding to a geographic location of the navigation system and a second GPS location signal corresponding to a geographic location of a vehicle, a processor operatively coupled to the transceiver, the processor configured to determine a relative distance of the navigation system from the vehicle based on the first GPS location signal and the second GPS location signal, and a user interface operatively coupled to the processor, the user interface provides an alert at a predetermined distance from the vehicle. In one embodiment, the processor may be configured to determine directional information from the geographic location of the navigation system to the geographic location of the vehicle. The transceiver may further be configured to receive and or transmit an identification code that identifies the vehicle/navigation system. The transceiver may also be configured to transmit the first GPS location signal to a vehicle transceiver, the vehicle transceiver being coupled to the vehicle. In one embodiment, the navigation system includes a siren activation system for actuating the transceiver to transmit the first GPS location signal and the identification code.

According to a feature of the present disclosure, the method for determining the presence of a vehicle at a predetermined distance from a navigation system is disclosed. The method includes receiving a first GPS location signal corresponding to a geographic location of the navigation system, receiving a second GPS location signal corresponding to a geographic location of the vehicle, mapping the first GPS location signal and the second GPS location signal to a geographical coordinate data, and alerting a user of the navigation system at a predetermined distance from the vehicle.

According to a feature of the present disclosure, a machine-readable medium is disclosed. The machine-readable medium provides instructions, which when read by a processor, cause the machine to perform operations including receiving a first GPS location signal corresponding to a geographic location of a navigation system, receiving a second GPS location signal corresponding to a geographic location of a vehicle, computing a relative distance of the navigation system from the vehicle based on the first GPS location signal and the second GPS location signal, and transmitting the relative distance to a user interface to provide an alert at a predetermined distance from the vehicle.

### DRAWINGS

The above-mentioned features and objects of the present disclosure will become more apparent with reference to the following description taken in conjunction with the accompanying drawings wherein like reference numerals denote like elements and in which:

FIG. 1 illustrates a satellite in communication with a plurality of devices having a navigation system, according to an embodiment of the present invention.

FIG. 2 is an exemplary block diagram of the hardware architecture for a navigation system, according to an embodiment of the present invention.

FIG. 3 is another exemplary block diagram of the hardware architecture for a navigation system, according to an embodiment of the present invention.

FIG. 4 is an exemplary flowchart outlining the operation of a navigation system, according to an embodiment of the present invention.

FIG. 5 is an exemplary flowchart outlining the operation of a navigation system on a passenger vehicle, according to an embodiment of the present invention.

FIG. 6 is an exemplary flowchart outlining the operation of a navigation system on a emergency vehicle, according to an embodiment of the present invention.

### DETAILED DESCRIPTION

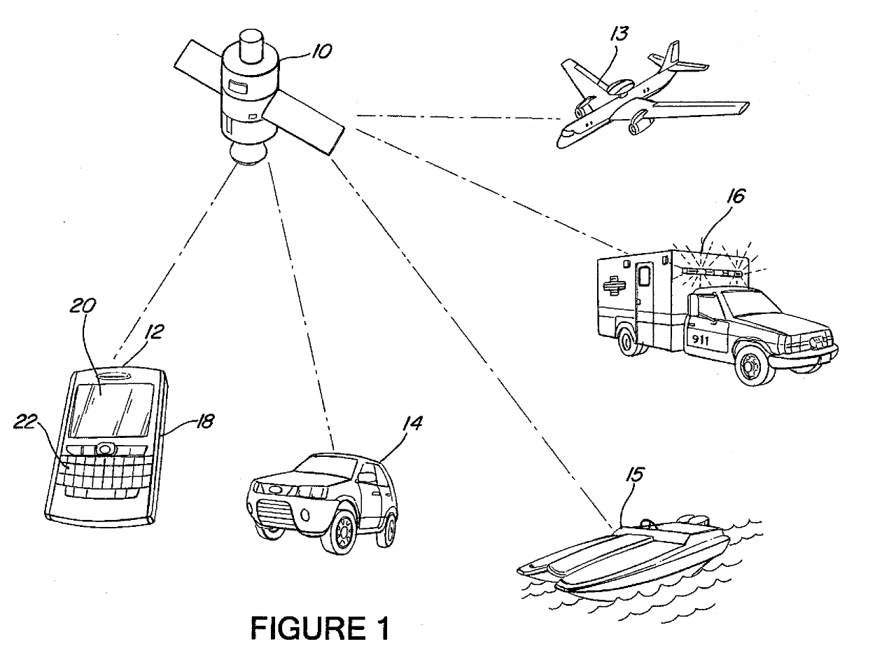

FIG. 1 illustrates a satellite 10 in communication with a plurality of devices having a navigation system. In one embodiment of the present invention, the satellite 10 may be in communication with navigation systems on a hand-held device 12, an aircraft 13, a passenger vehicle 14, a boat 15 and/or an emergency vehicle 16. As can be envisioned by a person skilled in the art, the vehicle may be any means of transport, for example, by sea, air or land. Each navigation system may include a housing 18, a display unit 20, an input device 22, a speaker (not shown), and internal hardware (not shown). The display unit 20 may be configured to display geographic information, directional information, points of interests, etc. The input device 22 may be used to enter an address for obtaining directional information. The address may be a plurality of characters and/or numbers and/or symbols for identification of a geographic location.

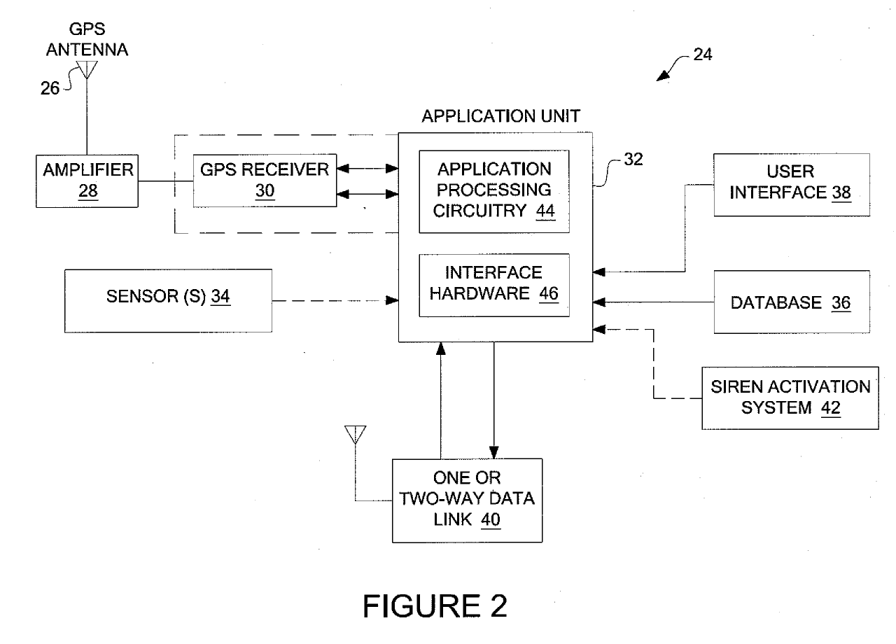

FIG. 2 is an exemplary block diagram of the hardware architecture for a navigation system 24. In this embodiment, the hardware architecture may include a GPS antenna 26, an amplifier 28, a GPS receiver 30, an application unit 32, one or more sensor(s) 34, a database 36, a user interface 38, a one or two-way communication link 40, and a siren activation system 42.

The GPS antenna 26 may be used to receive a first GPS location signal corresponding to a geographic location of the navigation system 24. The GPS antenna 26 may be coupled to amplifier 28 that amplifies the first GPS location signal received by the antenna 26. The amplifier 28 transmits the first GPS location signal to the GPS receiver 30. In one embodiment, the amplifier 28 is optional, and the GPS antenna 26 connects directly to the GPS receiver 30. The GPS receiver 30 continuously determines the geographic position by measuring the ranges (the distance between a satellite 10 with known coordinates in space and the GPS antenna 26) of several satellites 10 and computing the geometric intersection of these ranges. To determine a range, GPS receiver 30 measures the time required for the first GPS location signal to travel from the satellite 10 to the GPS antenna 26. The GPS receiver 30 provides the GPS measurements to the application unit 32. The application unit 32 may include an application processing circuitry 44 and an interface hardware 46.

The application processing circuitry 44 may include a processor, memory, busses, application software and related circuitry. The processor may be configured to determine a relative distance of the navigation system 24 from the vehicle 13-16. The processor may also be configured to determine directional information from the geographic location of the navigation system 24 to the geographic location of the vehicle 13-16. In one embodiment, the application unit 32 may be incorporated into the GPS receiver 30. The interface hardware 46 integrates various components of the navigation system 24 with the application unit 32. For example, the interface hardware 46 may be configured to integrate with sensor(s) 34, database 36, user interface 38, one or two-way data link 40, and siren activation system 42.

The sensor(s) 34 may be a direction (azimuth) sensor, such as a magnetometer, that equates the viewing direction of the navigation system 24 to the measurements obtained from the sensor 34, so that the displayed geographic information correspond to the geography/land objects/roads where the viewing direction is directed to. The database 36 may be used to store geographic information and provide such information to the application unit 32. The geographic information may include geographical coordinate data corresponding to land, sea and/or space coordinates. The user interface 38 may include the display unit 20, the input device 22 and the speaker (not shown). The user interface 38 allows interaction between the user and the navigation system. In one embodiment, the user interface 38 provides an alert when a vehicle 13-16 is at a predetermined distance from the navigation system 24. The display unit 20 may display an image of a vehicle that identifies the type and location of the vehicle 13-14 when located at a predetermined distance from the navigation system 24. For example, the display unit 20 may display an image of an emergency vehicle to correspond to the emergency vehicle 16 traveling in the direction of the navigation system 24, such as an image of an ambulance, police car, fire truck, etc. The speaker (not shown) may be used to provide a voice/audible alert to approaching emergency vehicle 16, for example, an ambulance traveling East approaching from the left or a fire truck traveling North approaching from the rear, etc.

The one or two way communication link 40 facilitates communication with satellites 10 to determine the directional information of a desired location. The one or two way communication link may be configured to receive a second GPS location signal corresponding to a geographic location of the vehicle 13-16. The one or two way communication link may further be configured to transmits and/or receive an identification code, such as a navigation system identification code that identifies the navigation system 24 or a vehicle identification code that identifies vehicle 13-16.

For example, the vehicle identification code allows the navigation system to recognize that an emergency vehicle 16 is approaching so that the driver of passenger vehicle 14 takes proper precautions to clear the path for the emergency vehicle 16. In another example, the vehicle identification code may be used to allow a driver of passenger vehicle 14 determine the presence of another passenger vehicle 14 on the road, even when there is poor visibility (i.e. fog). In yet another example, the vehicle identification code may also be used to allow friends that are driving together in separate passenger vehicles 14 from detecting one another even when separated or obstructed by other passenger vehicles 14. Likewise, the navigation system identification code can be used for aircraft 13 and boat 15 to determine the presence of other aircrafts 13 and boats 15, respectively.

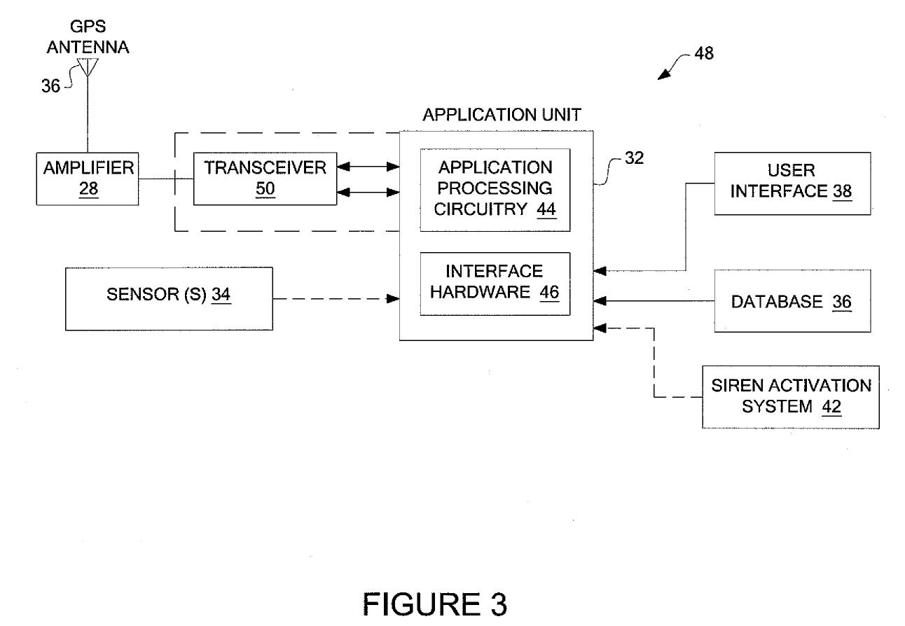

The siren activation system 42 triggers the navigation system 24 to transmit GPS location signals so that it may be received by another navigation system 24. The siren activation system 42 may also trigger the navigation system 24 to transmit the identification code. In one embodiment, the siren activation system 42 actuates the one or two way communication link 40 to transmit the GPS location signal and/or the identification code. In another embodiment, the siren activation system 42 actuates a transceiver 50 to transmit the GPS location signal and/or vehicle activation system, as shown in FIG. 3. By having the ability to trigger the navigation system 24 to transmit GPS location signals and/or identification code, emergency vehicle 16 can protect its anonymity when it is undesirable to disclose its location. Meanwhile, the emergency vehicle 16 can transmit its identity and location to provide time for passenger vehicle 14 to clear or avoid the path of emergency vehicle 16.

FIG. 3 is another exemplary block diagram of the hardware architecture for a navigation system 48. In this embodiment, the hardware architecture may include transceiver 50 configured to receive the first GPS location signal corresponding to the geographic location of the navigation system 48 and to receive the second GPS location signal corresponding to the geographic location of the vehicle 13-16. The transceiver 50 may be configured to transmit the first GPS location signal of navigation system 48 to another transceiver 50 of vehicle 13-16. The transceiver 50 may also be configured to transmit and/or receive an identification code that identifies the navigation system 49 and/or vehicle 13-16. The transceiver 50 is operatively coupled to the application processing circuitry 44. The application processing circuitry 44 includes a processor that may be configured to determine a relative distance of the navigation system 48 from the vehicle 13-16 based on the first GPS location signal and the second GPS location signal. In one embodiment, the processor may be configured to determine the likelihood of an emergency vehicle's path intersecting or approaching a predetermined distance from the navigation system 48. The navigation system 48 may transmit the relative distance to the user interface 38 to provide an alert at a predetermined distance from the vehicle 13-16.

The application unit 32 may be used to operate a software program that allows the navigation system 24 to determine the presence of a vehicle 13-16 at a predetermined distance from the navigation system 24. The software program may be stored in the database 36 and executed by the processor. The software program can be implemented using hardware, software or a combination of hardware and software. The database 36 can be implemented in a machine-readable medium, which may be any mechanism that provides (i.e. stores and/or transmits) information in a form readable by the processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. The database 36 may be used to store, arrange and retrieve data.

The machine readable medium may provide instructions, which when read by the processor, cause the machine to perform operations, such as receiving a first GPS location signal corresponding to a geographic location of the navigation system 24, 49, receiving a second GPS location signal corresponding to a geographic location of a vehicle 13-16, computing a relative distance of the navigation system 24, 49 from the vehicle 13-16 based on the first GPS location signal and the second GPS location signal, and transmitting the relative distance to the user interface 38 to provide an alert at a predetermined distance from the vehicle 13-16.

The machine readable medium may also provide instructions, which when read by the processor, cause the machine to perform operations, such as determining directional information from the geographic location of the navigation system 24, 49 to the geographic location of the vehicle 13-16; receiving and/or transmitting an identification code that identifies the navigation system 24, 49 and/or the vehicle 13-16; transmitting the first GPS location signal to transceiver 50 of another vehicle 13-16; and/or actuating siren activation system 42 to trigger the navigation system 24, 49 to transmit the first GPS location signal.

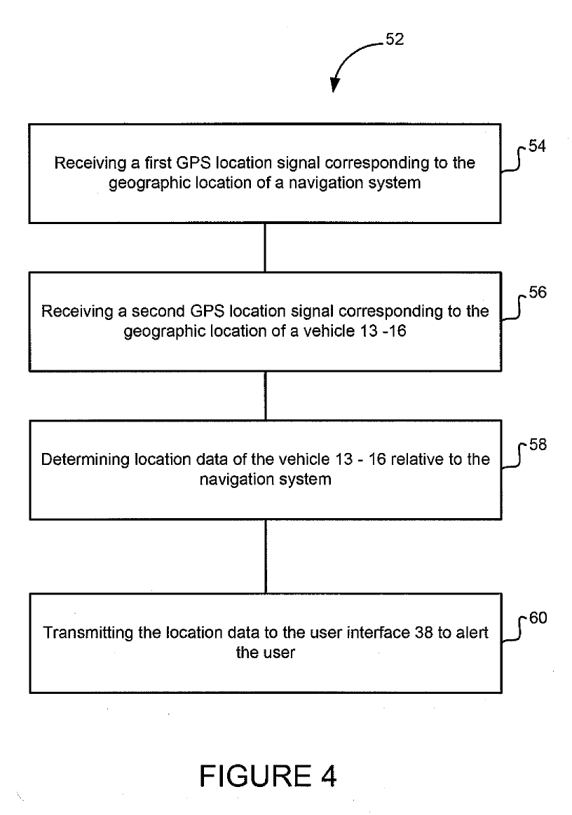

FIG. 4 is an exemplary flowchart 52 outlining the operation of a navigation system, according to an embodiment of the present invention. The navigation system determines the presence of vehicle 13-16 at a predetermined distance from the navigation system by receiving a first GPS location signal corresponding to a geographic location of the navigation system (54) and a second GPS location signal corresponding to a geographic location of the vehicle 13-16 (56). The application processing circuitry 44 may then be used to determine a location data of the vehicle 13-16 relative to the navigation system (58). For example, the processor of the application processing circuitry 44 may compute a relative distance of the navigation system from the vehicle 13-16 based on the first GPS location signal and the second GPS location signal. In another example, the processor may map the first GPS location signal and the second GPS location signal to the geographical coordinate data stored in database 36. Next, the location data, such as relative distance data, may be transmitted to the user interface 38 to provide an alert when a vehicle 13-16 is at a predetermined distance from the navigation system (60).

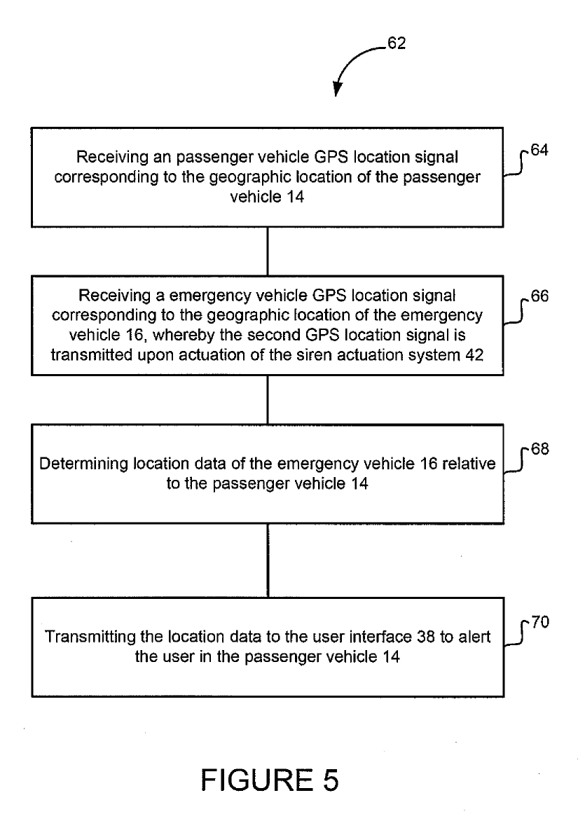

FIG. 5 is an exemplary flowchart 62 outlining the operation of a navigation system on passenger vehicle 14, according to an embodiment of the present invention. The navigation system of passenger vehicle 14 determines the presence of an emergency vehicle 16 at a predetermined distance from the passenger vehicle 14 by receiving a passenger vehicle GPS location signal corresponding to a geographic location of the passenger vehicle (64) and receiving an emergency vehicle GPS location signal corresponding to a geographic location of the emergency vehicle 16 (66). The emergency vehicle GPS location signal may be transmitted by the emergency vehicle 16 upon actuation of its siren activation system 42. The application processing circuitry 44 may then be used to determine a location data of the emergency vehicle 16 relative to the passenger vehicle 14 (68). Next, the location data, such as relative distance data, may be transmitted to the user interface 38 to provide an alert when the emergency vehicle 16 is at a predetermined distance from the passenger vehicle 14 (70).

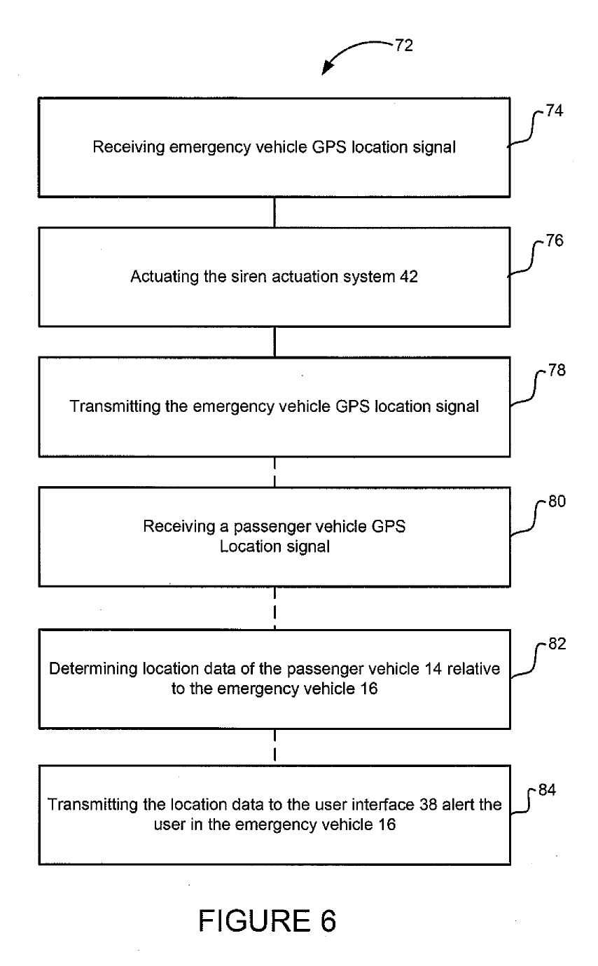

FIG. 6 is an exemplary flowchart outlining the operation of a navigation system on emergency vehicle 16, according to an embodiment of the present invention. The navigation system of emergency vehicle 16 may be used to notify or alert a passenger vehicle 14 the presence of the emergency vehicle 16 at a predetermined distance from the passenger vehicle 14 by receiving an emergency vehicle GPS location signal corresponding to a geographic location of the emergency vehicle 16 (74), actuating the siren activation system (76), and transmitting the emergency vehicle GPS location signal via transceiver 50 and/or data link 40 (78). In one embodiment, the navigation system of emergency vehicle 16 may be used to determine the presence of a passenger vehicle 14 at a predetermined distance from the emergency vehicle 16. For example, the navigation system of emergency vehicle 16 may receive a passenger vehicle GPS location signal corresponding to a geographic location of the passenger vehicle (80). The application processing circuitry 44 may then be used to determine a location data of the passenger vehicle 14 relative to the emergency vehicle 16 (82). Next, the location data, such as relative distance data, may be transmitted to the user interface 38 to alert the driver of the emergency vehicle 16 of approaching passenger vehicles 14 (84).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. For example, any combination which performs a functionally analogous task as application processing circuitry 44 is understood within the scope of the specification to be included within the definition of the server. Likewise, artisans understand that for the purpose of the instant disclosure, the application processing circuitry 44 may include any number of serially linked units performing these functions within the scope of this invention.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A navigation system, comprising:
a transceiver configured to receive a first GPS location signal corresponding to a geographic location of the navigation system and a second GPS location signal corresponding to a geographic location of a vehicle;
a processor operatively coupled to the transceiver, the processor configured to determine a relative distance of the navigation system from the vehicle based on the first GPS location signal and the second GPS location signal; and
a user interface operatively coupled to the processor, the user interface provides an alert at a predetermined distance from the vehicle.

2. The navigation system of claim 1, wherein the processor is further configured to determine directional information from the geographic location of the navigation system to the geographic location of the vehicle.

3. The navigation system of claim 1, wherein the transceiver is further configured to receive an identification code that identifies the vehicle.

4. The navigation system of claim 1, wherein the transceiver is further configured to transmit the first GPS location signal to a vehicle transceiver, the vehicle transceiver being coupled to the vehicle.

5. The navigation system of claim 1, wherein the vehicle is an emergency vehicle.

6. The navigation system of claim 1, further comprising a siren activation system for actuating the transceiver to transmit the first GPS location signal.

7. The navigation system of claim 1, wherein the transceiver is further configured to transmit a navigation system identification code to a vehicle transceiver, the navigation system identification code identifies the navigation system, the vehicle transceiver being coupled to the vehicle.

8. The navigation system of claim 1, wherein the user interface is selected from a group consisting of a display unit, an output device and a speaker system.

9. A machine readable medium that provides instructions, which when read by a processor, cause the machine to perform operations comprising:
receiving a first GPS location signal corresponding to a geographic location of a navigation system;
receiving a second GPS location signal corresponding to a geographic location of a vehicle;
computing a relative distance of the navigation system from the vehicle based on the first GPS location signal and the second GPS location signal; and
transmitting the relative distance to a user interface to provide an alert at a predetermined distance from the vehicle.

10. The machine readable medium of claim 9, further comprising determining directional information from the geographic location of the navigation system to the geographic location of the vehicle.

11. The machine readable medium of claim 9, further comprising receiving a vehicle identification code that identifies the vehicle.

12. The machine readable medium of claim 9, further comprising transmitting the first GPS location signal to a vehicle transceiver, the vehicle transceiver being coupled to the vehicle.

13. The machine readable medium of claim 9, wherein the vehicle is an emergency vehicle.

14. The machine readable medium of claim 9, further comprising actuating a siren activation system to trigger the navigation system to transmit the first GPS location signal.

15. The machine readable medium of claim 9, further comprising transmitting a navigation system identification code to a vehicle transceiver, the navigation system identification code identifies the navigation system, the vehicle transceiver being coupled to the vehicle.

16. The machine readable medium of claim 9, wherein the user interface is selected from a group consisting of a display unit, an output device and a speaker system.

17. A method for determining the presence of a vehicle at a predetermined distance from a navigation system, the method comprising:
receiving a first GPS location signal corresponding to a geographic location of the navigation system;
receiving a second GPS location signal corresponding to a geographic location of the vehicle;
mapping the first GPS location signal and the second GPS location signal to a geographical coordinate data; and
alerting a user of the navigation system at a predetermined distance from the vehicle.

18. The method of claim 17, further comprising computing a relative distance of the navigation system from the vehicle based on the first GPS location signal and the second GPS location signal.

19. The method of claim 17, further comprising displaying an image of the vehicle on a display unit of the navigation system.

20. The method of claim 17, further comprising actuating a siren activation system to trigger the navigation system to transmit the first GPS location signal.
